(19) United States
(12) Patent Application Publication
(10) Pub. No.: US 2004/0168755 A1
(43) Pub. Date: Sep. 2, 2004

(54) Method of making three-dimensional design

(76) Inventor: Steven N. Parker, Eastlake, OH (US)

Correspondence Address: WATTS, HOFFMANN, FISHER & HEINKE CO., L.P.A., 1100 Superior Ave., Ste. 1750, Cleveland, OH, 44114, US

(21) Appl. No.: 10/375,857

(22) Filed: Feb. 28, 2003

(51) Int. Cl. B44C 1/00

(52) U.S. Cl. 156/63; 156/245

(57) ABSTRACT

A method for making a three-dimensional design on an exterior surface of a object. The method includes the steps of determining a desired three-dimensional design, creating an article corresponding to the three-dimensional design from a compound material, fixedly applying the article to the exterior surface of the object and treating the exposed surface of the article and at least a portion of the exterior surface of the object adjacent to the article. The method may be used on motorcycles and other vehicles. The intersecting surfaces of the object and article may be sanded, primed and painted to create an essentially uniform common surface. The article may have a mating surface for cooperatively adhering to an arcuate vehicle surface. A flexing agent may be added to the compound to increase the flexibility of the article.

### FIELD OF THE INVENTION

The present invention relates generally to making three-dimensional designs. More specifically, the invention is directed to a method for making three-dimensional designs on an exterior surface of an object.

### BACKGROUND OF THE INVENTION

The aesthetic appearance of a functional object is commonly improved by altering or changing the appearance of the object's visible exterior surface. Improving the aesthetic appearance of an object that is used to provide transportation or motion to a person is especially popular. Well-known objects of this type include automobiles, motorcycles, jet skis, boats, all-terrain vehicles, gliders, airplanes, snowmobiles, snowboards and surfboards. It is common for the manufacturer of an object of this type to utilize attractive designs or shapes for the surface of the object to increase demand for the object with consumers. While increasing the aesthetic appeal, it is important to not decrease the functionality of the object.

Various methods have been proposed and are common in the art to provide designs and shapes to an object's exterior surface. The appearance of an object may be improved by the use of coatings, such as paint or transparent liquids. Decals, stickers, chrome and other metallic substances may also be used to create designs. Further, objects may be constructed to include three-dimensional designs to increase the aesthetic appearance of the object.

Conventionally, three-dimensional designs or patterns are designed and constructed by the manufacturer. Manufacturing techniques include stamping sheet metal and molding body panel parts from various plastics. These and other techniques are typically utilized by the original equipment manufacturer, as opposed to after-market shops or end-consumers. Further, these manufacturing techniques are limited in their flexibility for producing a variety of unique designs.

Various after-market solutions have been proposed to add three-dimensional designs to the exterior surface of a vehicle. One solution involves the application of stickers having a three-dimensional body and an adhesive-backed surface. The stickers are purchased by end consumers in a predetermined design and merely applied by the vehicle owner at desired locations on the vehicle's exterior surface. However, it is believed that this solution has several design shortcomings. The construction of the stickers does not provide a three-dimensional surface that is resilient to common application environment forces, as is the vehicle's surface. As a result, after the stickers are applied they are susceptible to damage when hit or contacted. The significance of this shortcoming becomes more apparent in the common use environment of certain vehicles, such as motorcycles. Further, the stickers can not be painted, repaired or otherwise revised after application.

As a practical matter, the three-dimensional exterior surface condition of many objects is currently limited to the factory issued condition of the object. It is believed that certain owners of one of the above-enumerated objects desire unique features that differentiate their vehicle from other factory issued vehicles. Further, vehicle manufacturers desire alternative methods to produce appealing three-dimensional designs. As a result, there remains a need in the art for a method of making a three-dimensional design on an object's exterior surface that creates a physical design having mechanical properties equal or superior to the exterior surface, while at the same time offering a variety of aesthetic design options.

### SUMMARY OF THE INVENTION

The present invention is directed to a method of making a three-dimensional design on the exterior surface of an object. The invention provides a design that advantageously offers desired physical properties and a variety of aesthetic properties.

In one embodiment of the present invention, a method for making a three-dimensional design on an exterior surface of a object includes the first two steps of determining a desired three-dimensional design, and creating an article corresponding to the three-dimensional design. The article is formed by a compound material and has a three-dimensional exposed surface and a mating surface. The last two steps of the method include fixedly applying the article to the exterior surface of the object, and treating the exposed surface of the article and at least a portion of the exterior surface adjacent to the article.

The step of creating an article corresponding to the three-dimensional design may include the steps of creating a mold having a negative-relief image of the desired three-dimensional design, casting the compound material into the mold, and curing the compound material to create the article. The step of creating an article corresponding to the three-dimensional design may includes the step of creating a sample of the desired three-dimensional design by hand carving the sample from a piece of closed cell foam.

The exterior surface may be an exterior surface of a vehicle, such as a motorcycle. The mating surface of the article may be essentially flat. The compound material used to form the article may be an epoxy resin or a polyester resin.

The step of treating the article may include the steps of applying a bead of a filling material along at least a portion of the intersection between the object and an outermost edge of the article, sanding at least portions of the exposed surface of the article and the exterior surface adjacent to the intersection, priming at least the sanded portions of the exposed surface of the article and the exterior surface of the object, and painting at least the primed portions of the exposed surface of the article and the exterior surface of the object.

The step of fixedly applying the article to the exterior surface of the object may include the step of applying double-sided tape to the mating surface of the article. Alternatively, the step may include the step of applying adhesive to the mating surface of the article.

The step of treating the article may include the step of applying a bead of a filling material along at least a portion of the intersection between the object and the outermost edge of the article, wherein the filling material is a polyester resin.

The created article may be resistant to chemical damage from exposure to gasoline. The created article may have a mechanical hardness at least as great as a mechanical hardness of the exterior surface of the object, whereby the article is resistant to mechanical damage.

The method of the present invention may include the step of applying the article to an arcuate surface of a vehicle. The steps of the present invention may be performed on a vehicle outside of an original equipment manufacturer environment.

The step of treating the article may include the step of smoothing an intersection dividing the article and the object, such that the exposed surface and the exterior surface form an essentially uniform common surface.

The step of creating an article corresponding to the three-dimensional design may include the step of adding a flexing agent to the compound material, wherein the flexing agent increases the flexibility of the article.

Other objects and advantages and a fuller understanding of the invention will become apparent to those skilled in the art from the following detailed description of the preferred embodiments and the accompanying drawings.

### BRIEF DESCRIPTION OF THE DRAWINGS

FIG. 1 is a perspective view of a vehicle having a three-dimensional design on a surface of a vehicle section, the design made in accordance with the present invention;

FIG. 2 is a perspective view of a section of the vehicle shown in FIG. 1, showing a three-dimensional design made in accordance with the present invention;

FIG. 3 is a partial sectional view of the section shown in FIG. 2 as seen approximately from a plane taken along the lines 3-3 of FIG. 2;

FIG. 4 is a perspective view of a process step taken in accordance with the present invention, showing a sample of a desired design and a mold;

FIG. 5 is a horizontal sectional view of the mold shown in FIG. 4 as seen approximately from a plane taken along the lines 5-5 of FIG. 4;

FIG. 6 is a horizontal sectional view of the mold shown in FIG. 5, showing the mold filled with a molding material;

FIG. 7 is a partial sectional view of a process step taken in accordance with the present invention, showing a molded article in relation to an arcuate surface of a vehicle section;

FIG. 8 is a partial sectional view of a process step taken in accordance with the present invention, showing the molded article of FIG. 7 adhered to the vehicle section surface;

FIG. 9 is a partial sectional view of a process step taken in accordance with the present invention; and

FIG. 10 is a perspective view of an alternative design molded article made in accordance with the present invention.

### DESCRIPTION OF THE INVENTION

The present invention is directed to a method for making three-dimensional designs on the exterior surface of an object. The method can be used to create a three-dimensional design on the surface of a vehicle, such as an automobile, motorcycle, jet ski, boat, all-terrain vehicle, glider, airplane, snowmobile, snowboard or surfboard. The method steps of the present invention can advantageously be performed on a vehicle outside of an original equipment manufacturer environment. For example, the method can be used to apply a three-dimensional design to the exterior surface of a motorcycle gas tank, or to the exterior surface of a surfboard fin. It should be understood by others with ordinary skill in the art, that the present invention may be used to make a three-dimensional design on a wide variety of objects, both in an original equipment factory setting and in an after market environment, such as a repair shop or a custom shop.

The preferred embodiment of the present invention will now be described. The process begins with cleaning and degreasing the entire object surface. After cleaning, the surface may be roughened prior to applying the molded article.

The molded article may be created by several different processes. In one embodiment of the present invention, the molded article is created by a stereolithography process. Stereolithography is a known fabrication technology for producing low-volume three-dimensional models. As a result of the accuracy and surface finish it produces, it has become a popular technique for the rapid prototyping of models. Several stereolithography processes exist. In one process, a layered manufacturing method is used that utilizes a photo-curable liquid resin in combination with an ultraviolet laser. A vat of the resin sits underneath the laser, and the laser “draws” on the top layer of liquid. When the ultraviolet laser beam hits the liquid it hardens a small amount of resin under the beam point. By drawing the outline, then filling the outline of a layer, a solid layer of material is created. This layer is then lowered a small distance into the vat, a new layer of liquid is placed on top, and the process repeats itself. By creating one flat layer at a time, a very precise geometry can be created resulting in a complete part.

Alternatively, the molded article may be made by a multi-step process. First, the design of the molded article must be determined. The article may be an original design, or an existing design may be used. The existing design may be a toy, a craft item, or any three-dimensional object suitable for applying to the surface of a larger object. If an original design is to be used, a positive relief sample of the original design may be created. The positive relief can be created from wood, closed cell foam, or any other suitable material. The material may be cut to shape using hand held tools, such as files, saws, razor blades, air powered tools, sand paper, lasers and the like. Alternatively, the article may be formed from precision automated equipment, such as a CNC machine or programmable laser equipment. To further strengthen the sample, the sample may be wrapped with a protective layer, such as pantyhose or fiberglass cloth. The sample can be coated with an epoxy for protection or to hold the protective layer in place.

After the positive sample is formed, the surface is sanded and seal with a liquid coating. UV cure epoxy, time cure epoxy, primer and paint, polyester resin, and spackle are all acceptable coatings. It should be understood by others with ordinary skill in the art that other techniques for making a positive sample may be used in the practice of the present invention.

The next step of the invention is making a negative relief mold suitable for creating a three-dimensional article. This step is performed by first pushing the positive sample, or selected three-dimensional object, into a mold-making compound. The mold-making compound should be contained in a vessel. The compound may be soft modeling clay, plumbers putty, children's putty, art craft clay, or any other known suitable compound. The sample is then removed from the mold-making compound, and the mold is cured by known methods. Alternatively, a molding plaster may be used to create a mold. The positive sample may be wrapped with fiberglass and epoxy. Once cured, the closed cell foam may be hollowed out to leave the desired mold.

The mold may alternatively be created without benefit of a positive sample. A mold may be carved out of wax or any other suitable material. Further, a pre-formed mold may be used, such as a cookie, candy, craft or ceramic mold. The mold can be also made from various other techniques, including laser cutting techniques.

After a suitable mold has been created, the mold is filled with a molding compound to create the molded article. The molding compound may be any suitable compound known in the art, such as a commercially available epoxy resin or polyester resin. A suitable portion of a flexing agent may be mixed into the molding compound, such as Actipol Polybutene. After the mold is filled, the compound is cured by known methods. After curing, the molded article is removed from the mold.

The article is now applied to the object surface. The surface may be arcuate requiring the molded article to be flexible such that a mating surface of the article mates flush with the exterior surface of the object. Several known application techniques may be used to join the mating surface to the object including double-sided tape, epoxy, super glue, contact cement, polyester resin and UV cure epoxy. It should be understood by one with ordinary skill in the art that any suitable method may be used that results in the molded article being permanently fixed to the surface of the object.

The present invention includes the step of treating the surface of the object and the surface of the molded article. The area that may receive the most treatment is the area near the intersection of the object's surface and the perimeter of the exposed surface of the article. This step may include applying a bead of a filling material around the outermost edge of the article. Any gaps between the molded article and the object are filled in, along with any small voids or holes in the surface of either the molded article or the object. The filling material may be epoxy and micro balloons, polyester resin, epoxy putty, lacquer paste, UV cure epoxy or any other suitable filling material know in the art. The filler material and adjacent portions of the molded article and object may be sanded until smooth.

Subsequently, the treated portions are primed and prepared for painting. During the priming step, the entire molded article may be primed to fill in pits or low spots in the article. Next, the molded article and adjacent object surface is painted with a desired finish paint. Further finishing steps may be performed, such as air brushing or clear coating and additional sanding treatment. The article may be covered with a chrome layer.

The present invention exhibits several advantageous benefits as compared to other techniques known in the art, such as peel-on stickers. The method step allows for a flexible molded article to be installed in a wide variety of application environments, specifically including arcuate surfaces. The surfaces may be constructed of a variety of painted or unpainted surfaces, including fiberglass, glass, plastic, metal, ceramic and wood. The article may be encapsulated in epoxy and paint such that no foreign substances can hinder the adhesion of the molded article to the surface. After the molding fully cures, the three-dimensional design hardens such that it is resistant to denting and other damage from conventional forces in most application environments. Further, the epoxy used by the applicant in one embodiment has been found to be chemically resistant to certain substances, including gasoline. The molded article is also temperature resistance with essentially no expansion or contraction at least at a temperature range between −20° F. and 200° F.

The invention has many post-application advantages as well. After application, the shape of the three-dimension design may be revised with additional sanding and/or application of compound material. If small chips do occur in the design, repair can be readily done without having to replace the entire design.

The present invention is described in a manual technique embodiment. It should be understood by others with ordinary skill in the art that the present invention may also be practiced in a mass-production environment with semi-automatic or automatic equipment.

### DETAILED DESCRIPTION OF THE PREFERRED EMBODIMENTS

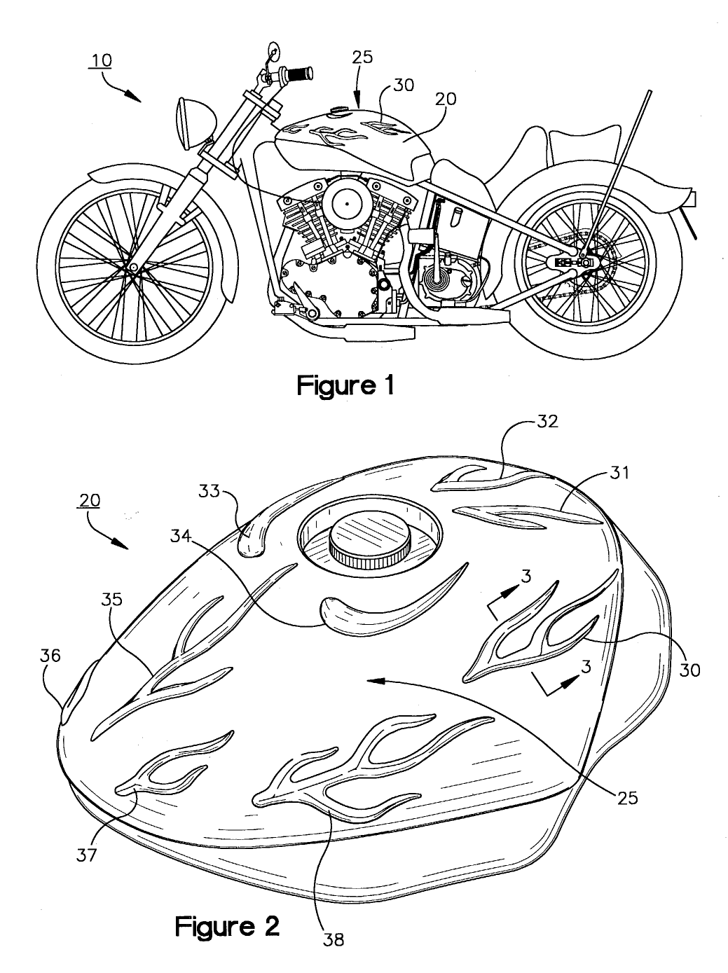

A vehicle 10 having an exterior surface 25 containing a three-dimensional design 30 made in accordance with a method of the present invention is illustrated in FIG. 1. As shown in the perspective view illustrated in FIG. 1, the vehicle is a motorcycle 10 that includes a gas tank 20 having an exterior surface 25. It should be apparent to others with ordinary skill in the art in view of this disclosure, that the present invention may be practiced on other vehicle surfaces.

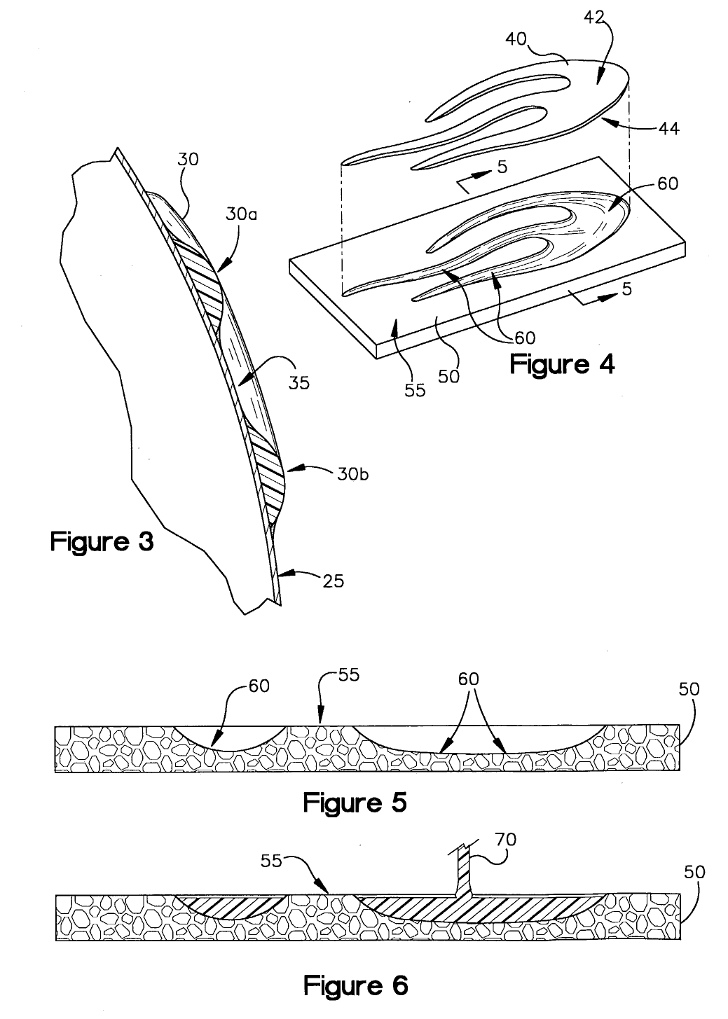

Referring now to FIG. 2, a perspective view of the gas tank 20 shown in FIG. 1 is illustrated. In the practice of the invention, one or more three-dimensional designs may be created on the surface of a vehicle. The exterior surface 25 of the gas tank 20 includes a plurality ofthree-dimensional designs 30, 31, 32, 33, 34, 35, 36, 37, 38. As shown, the designs 30, . . . 38 are three-dimensional patterns having arcuate structures to resemble flames. A partial sectional view of one exemplary design 30 is shown in FIG. 3.

As mentioned, a partial sectional view of the gas tank 20 shown in FIG. 2 is illustrated in FIG. 3, as seen approximately from a plane taken along the lines 3-3 of FIG. 2. The design 30 as shown has at least two branches 30a, 30b separated by a portion 35 of the gas tank exterior surface 25. For exemplary purposes only, the method steps to produce the single three dimensional design 30 will now be discussed. However, it should be apparent to others with ordinary skill in the art in view of this disclosure that in a preferred embodiment with a plurality of designs such as shown in FIG. 2, the same steps are repeated for the other designs 31, . . . 38 and may be performed concurrently or subsequently for each individual design structure.

A method of the present invention includes the step of determining a desired three-dimensional design. In the embodiment illustrated in FIG. 2, the design 30 is a multiple branch flame design. Alternative flame designs 31, 32, 33, 34, 35, 36, 37, 38 are shown in FIG. 2. A perspective view of an alternative design of a starfish 39 is shown in FIG. 10. After the method step of determining a design is completed, the next step may be initiated.

The next step of the present invention is creating an article corresponding to the desired three-dimensional design. In one embodiment, the method step of creating an article corresponding to the three-dimensional design includes the first step of creating a sample of the desired three-dimensional design by hand carving the sample from a piece of closed cell foam. A block of closed cell foam is carved using conventional tools such as knives, files, saws, or sand paper. FIG. 4 is a perspective view of a process step taken in accordance with the present invention, showing a sample 40 of the design. The sample 40 is illustrated including an essentially flat surface 42. As illustrated, the sample is shown “upside down” with only a small portion of the three-dimensional surface 44 of the flame design visible.

In the preferred embodiment, the step of creating an article corresponding to the three-dimensional design further includes the initial step of creating a mold having a negative-relief image of the desired three-dimensional design. The negative-relief image is created by inserting a sample into a contained amount of molding-making material. Referring again to FIG. 4, a sample 40 is illustrated after it has been removed from the mold 50. The mold as illustrated is rectangular-shaped although is should be apparent to others with ordinary skill in the art that the mold may be of any suitable shape in the practice of the present invention. The mold 50 includes indented surfaces below the top surface 55 of the mold 50 that define a negative image 60 of the sample 40. The indented surfaces below the top surface 55 defining the negative image 60 are also illustrated in FIG. 5. As illustrated, FIG. 5 is a horizontal sectional view of the mold 50 shown in FIG. 4 as seen approximately from a plane taken along the lines 5-5 of FIG. 4. As mentioned, the mold 50 may be created by a stereolithography process. By use of this process, the steps of creating a sample are not performed. Regardless, it should be apparent to others with ordinary skill in the art that these and other mold making techniques may be used in the practice of the present invention.

The next step of the preferred embodiment includes casting the compound material into the mold and subsequently curing the compound material to create the desired three-dimensional article. A horizontal sectional view of the mold shown in FIG. 5, showing the mold 50 being filled with a molding material 70 is illustrated in FIG. 6. For exemplary purposes, the compound material 70 may be a known epoxy resin or a polyester resin. It should be apparent to others with ordinary skill in the art in view of this disclosure, that other materials may be used to create a suitable article in the practice of the present invention.

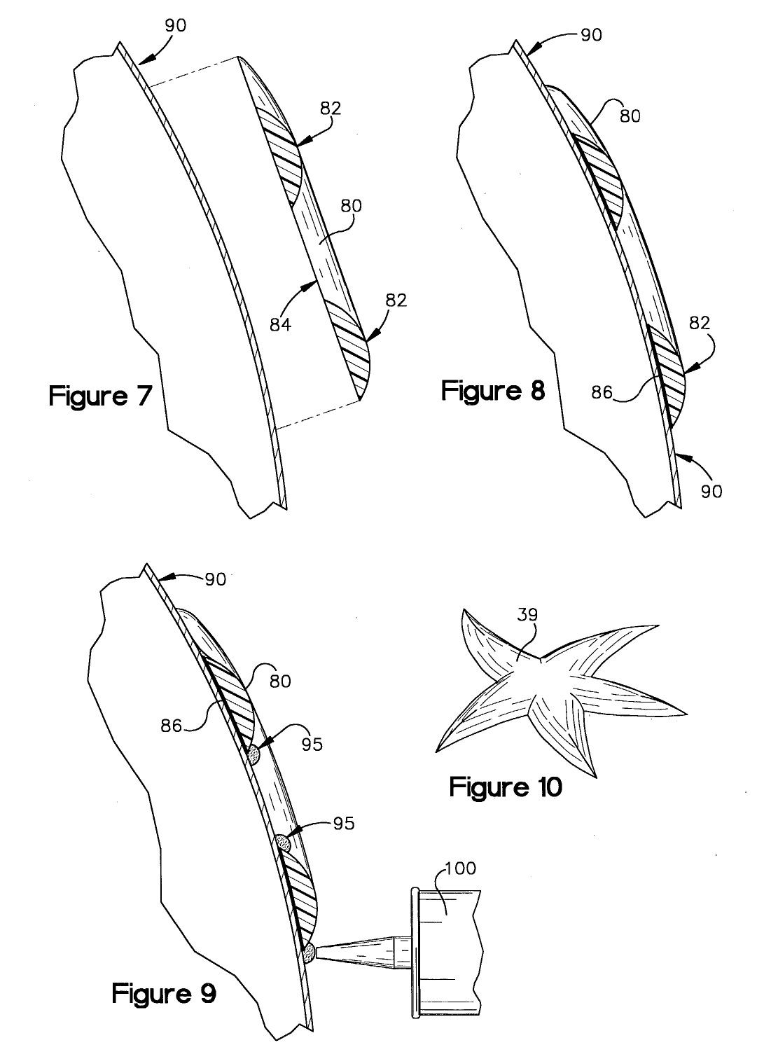

As discussed, the article is formed by pouring a compound material into a pre-made mold. Once cured by any one of several suitable methods, the article is removed from the mold for use in the next step of the invention. A cured article 80 is illustrated in FIG. 7. A partial sectional view is illustrated in FIG. 7, showing a molded article 80 in relation to a vehicle surface 90 of a vehicle. As illustrated, the vehicle surface 90 is the exterior surface of a motorcycle gas tank. The article includes a three-dimensional exposed surface 82 and a mating surface 84. As illustrated, the mating surface 84 is essentially flat. The mating surface 84 is relatively smooth for cooperatively mating with the vehicle surface. The mating surface 84 may advantageously bend to mate with an arcuate vehicle surface 90.

The article 80 is preferably resistant to damage from the application environment into which it will be installed. Preferably, the article 80 is resistant to chemical damage from exposure to gasoline. Preferably the article is also resistant to physical damage. The article may have a mechanical hardness at least as great as a mechanical hardness of the exterior surface of the object to which it is installed. Because of this mechanical hardness quality, the article may be suitably resistant to mechanical damage.

Other improvements may be made to the article. The step of creating an article may include adding a flexing agent to the compound material. In this step, the selected flexing agent is mixed with the compound prior to being poured into the mold. The flexing agent increases the flexibility of the article after it is cured. Increased flexibility may improve the article's performance in the next subsequent method step, allowing the article 80 to be mounted to a variety of flat and arcuate surfaces.

The next method step includes fixedly applying the article to the exterior surface of the selected object. As discussed, in an exemplary method the article 80 is applied to the exterior surface 90 of a motorcycle gas tank 20. FIG. 8 is a partial sectional view of a the molded article 80 illustrated in FIG. 7 adhered to the gas tank surface 90. The article 80 can be applied to the surface 90 by several techniques, including using double-sided tape between the mating surface 84 and the vehicle surface 90. Alternatively, conventional adhesive may be used between the mating surface 84 and the vehicle surface 90. As shown in FIGS. 8 and 9, a layer of adhesive 86 joins the mating surface 84 and the vehicle surface 90. The vehicle surface 90 may be flat, or as in the illustrated embodiment, the exterior surface 90 may be arcuate.

The next method step includes treating the exposed surface of the article and a portion of the vehicle exterior surface adjacent to the article. FIG. 9 is a partial sectional view of one embodiment of this process step. The step results in a smooth surface between the article and the vehicle such that the three-dimensional design appears uniform with the gas tank. The step of treating the article may include applying a bead of a filling material along the intersection between the object and an outermost edge of the article. As illustrated in FIG. 9, a tube 100 of filling material is used to apply a bead 95 around the exterior perimeter of the article 80. In a preferred embodiment, the filling material is polyester resin.

After the bead is applied, portions of the exposed article surface and portions of exterior surface adjacent to the bead material are sanded. The sanding may be performed by hand sanding, a small automatic sander, or any other conventional method. In a preferred embodiment, the intersection of the vehicle surface and the article exterior surface form an essentially uniform common surface. After the sanding creates a smooth transition between the article and the vehicle surface, the sanded portions of the article and the exterior vehicle surface may be primed. Lastly, the primed areas are then painted. Other conventional finishing techniques may also be used, such as clear coat protections.

Many variations and modifications of the invention will be apparent to those skilled in the art from the above detailed description of the preferred embodiment. Therefore, it is to be understood that, within the scope of the appended claims, the invention can be practiced otherwise than as specifically shown and described.

What is claimed is:

1. A method for making a three-dimensional design on an exterior surface of a object, said method comprising the steps of:
a) determining a desired three-dimensional design;
b) creating an article corresponding to said three-dimensional design, said article formed by a compound material and having a three-dimensional exposed surface and a mating surface;
c) fixedly applying said mating surface to said exterior surface of said object; and
d) treating said exposed surface of said article and at least a portion of said exterior surface adjacent to said article.

2. The method of claim 1 wherein said exterior surface is an exterior surface of a vehicle.

3. The method of claim 1 wherein said step of creating an article corresponding to said three-dimensional design includes the steps of:
i) creating a mold having a negative-relief image of said desired three-dimensional design;
ii) casting said compound material into said mold; and
iii) curing said compound material to create said article.

4. The method of claim 1 wherein said step of creating an article corresponding to said three-dimensional design includes the step of creating a sample of said desired three-dimensional design by hand carving said sample from a piece of closed cell foam.

5. The method of claim 1 wherein said compound material is an epoxy resin.

6. The method of claim 1 wherein said compound material is a polyester resin.

7. The method of claim 1 wherein said mating surface is essentially flat.

8. The method of claim 1 wherein said article is flexible whereby said step of fixedly applying said mating surface to said exterior surface of said object is performed when said exterior surface is arcuate.

9. The method of claim 1 wherein said step of treating said article includes the steps of:
i) applying a bead of a filling material along at least a portion of the intersection between the object and an outermost edge of the article;
ii) sanding at least portions of said exposed surface of said article and said exterior surface adjacent to said intersection;
iii) priming at least the sanded portions of said exposed surface of said article and said exterior surface of said object; and
iv) painting at least the primed portions of said exposed surface of said article and said exterior surface of said object.

10. The method of claim 1 wherein said step of fixedly applying said mating surface to said exterior surface of said object includes the step of applying double-sided tape to said mating surface of said article.

11. The method of claim 1 wherein said step of fixedly applying said mating surface to said exterior surface of said object includes the step of applying adhesive to said mating surface of said article.

12. The method of claim 1 wherein said step of treating said article includes the step of applying a bead of a filling material along at least a portion of the intersection between the object and the outermost edge of the article, wherein said filling material is a polyester resin.

13. The method of claim 1 wherein said article is resistant to chemical damage from exposure to gasoline.

14. The method of claim 1 including the step of creating an article with a mechanical hardness at least as great as a mechanical hardness of said exterior surface of said object, whereby said article is resistant to mechanical damage.

15. The method of claim 1 including the step of applying said article to an arcuate surface of a vehicle.

16. The method of claim 1 wherein said steps are performed on a vehicle outside of an original equipment manufacturer environment.

17. The method of claim 1 wherein said step of treating said article includes the step of smoothing an intersection dividing said article and said object, such that said exposed surface and said exterior surface form an essentially uniform common surface.

18. An article made by the method steps of claim 1, wherein said article is comprised of epoxy resin and includes a mating surface for adherence to an exterior surface of a vehicle.

19. The method of claim 1 wherein said step of creating an article corresponding to said three-dimensional design includes the step of adding a flexing agent to said compound material, wherein said flexing agent increases the flexibility of said article.

20. A method for making a three-dimensional design on an exterior surface of a vehicle, said method comprising the steps of:
a) determining a desired three-dimensional design;
b) creating an article corresponding to said three-dimensional design, said article formed by a compound material and having a three-dimensional exposed surface and a mating surface, including the steps of:
i) creating a mold having a negative-relief image of said desired three-dimensional design;
ii) casting said compound material into said mold; and
iii) curing said compound material to create said article; and
c) fixedly applying said article to said exterior surface of said object; and
d) treating said exposed surface of said article and at least a portion of said exterior surface adjacent to said article, including the steps of:
i) applying a bead of a filling material along at least a portion of the intersection between the object and an outennost edge of the article;
ii) sanding at least portions of said article and said exterior surface adjacent to said intersection;
iii) priming at least the sanded portions of said exposed surface of said article and said exterior surface of said object; and
iv) painting at least the primed portions of said exposed surface of said article and said exterior surface of said object.
